(19) United States
(12) Patent Application Publication
(10) Pub. No.: US 2002/0103711 A1
(43) Pub. Date: Aug. 1, 2002

(54) Online method and system for ordering and having delivered a paper greeting message and payment instrument

(76) Inventors: Peter Michael Karas, Lakewood, CO (US); James Everett Cowell, Littleton, CO (US)

Correspondence Address: MORRIS, MANNING & MARTIN LLP, 6000 FAIRVIEW ROAD, SUITE 1125, CHARLOTTE, NC, 28210, US

(21) Appl. No.: 09/737,912

(22) Filed: Dec. 15, 2000

(51) Int. Cl. G06F 17/60

(52) U.S. Cl. 705/26

(57) ABSTRACT

A online method and system by which a sender can order and have delivered to a recipient a printed greeting message having a negotiable payment instrument included therewith or attached thereto is disclosed. The method enables the sender to pre-select the basic format of the greeting message based on the occasion for sending the greeting message and payment instrument. Based on the occasion, the system suggests a graphic and message that can be included in the greeting message. The sender can accept the suggested graphic and message or customize one or both. The sender also selects the amount of the payment instrument and pays for the cost of the payment instrument and other related fees and charges using online methods. Once payment authorization has been received, the greeting message and payment instrument are printed using known printing techniques, inserted into an envelope, and mailed to the recipient.

### FIELD OF THE PRESENT INVENTION

The present invention relates broadly to the transmission of customized messages and, more particularly, to the virtual creation and realworld delivery of a customized paper greeting message having a negotiable payment instrument included therewith or attached thereto.

### BACKGROUND OF THE INVENTION

For many years, people have exchanged greeting messages with one another to celebrate holidays and special occasions. It has also been commonplace for an individual to include money or a check inside one of these cards when the holiday or special occasion, such as a Birthday, Christmas, Bar Mitzvah, or Graduation, calls for the giving of a gift.

With the advent of the Internet, it is now possible for a sender to order a paper greeting message online, provide information about herself and the recipient of the greeting message, and have the paper greeting message sent to the recipient directly from the online card seller. It is now also possible to request that a gift certificate be enclosed within such a greeting message ordered online. Such a combination of mass-produced paper greeting messages and an enclosed gift certificate is currently offered jointly by Hallmark.com and GiftCert.com. Other web sites, such as Blockbuster.com, enable the sender to customize the greeting message before inclusion of the gift certificate or gift card redeemable at the particular retail establishment. Unfortunately, with either of these systems, there is no means for attaching or transmitting therewith an actual negotiable payment instrument, such as a check or money order, which is cashable by the payee by depositing the same into the banking system, which processes the instrument through normal bank clearing channels.

Other web sites, such as BidPay.com, enable purchasers of an item from an auction web site to request a money order that can be mailed directly to the seller of the auctioned item to expedite the transfer of the auctioned item from the seller to the purchaser. Once a successful bid has been made for an item at an auction web site, the purchaser can choose to pay for the item by clicking on a BidPay.com logo, which links the purchaser to the BidPay.com web site. After the purchaser enters all of the necessary contact and billing information and after payment authorization has been received, a money order is printed out and mailed to the seller of the auctioned item. The money order is generally printed on an 8.5″×11″ sheet of pre-printed paper and is divided into two portions. Typically, one portion is the actual negotiable money order and the other portion is the accounting stub that contains the relevant information about the item being purchased as well as the contact information for the seller and the purchaser. Such money orders can be printed using known automated printing processes. However, as the BidPay.com web site explains, money orders are only available for auction related purchases. Additionally, the BidPay.com web site does not provide for nor is there a suggestion or reason for the purchaser to include a personalized greeting message and selected graphic image to the seller on the “accounting stub” portion of the money order.

As will be apparent from the foregoing description of the Hallmark.com, Blockbuster.com, and BidPay.com web sites, there is currently a need for an individual to be able to order a paper greeting message online and request that some form of negotiable payment instrument be included therewith or attached thereto. For fraud and security reasons, a negotiable payment instrument is preferable to a generic gift certificate or gift card since the negotiable instrument can be made payable to the recipient of the message, to another payee, to a specific merchant, or to both a payee and a specific merchant. Preferably, such negotiable payment instrument would be removeably attached to the paper greeting message, which would avoid the manual or highly automated processes for inserting the payment instrument into the card. In addition, it is preferable that such payment instrument be capable of being printed at the same time as the paper greeting message. Further, there is a need for an individual to be able to order a payment instrument online as a gift to another individual and to include an appropriate customized message and graphic image that can be displayed on the message portion of the payment instrument. The present invention addresses these particular needs in the industry.

### BRIEF SUMMARY OF THE PRESENT INVENTION

Briefly described, the present invention includes, in a computerized system, a method of creating a printed greeting message having a negotiable payment instrument included therewith, and comprising the steps of enabling a sender of the message to select a graphic image for inclusion in the message to a recipient, enabling the sender to input customized text for inclusion in the message, enabling the sender to specify a payee and the monetary value of the negotiable payment instrument, and printing the message and negotiable payment instrument. The message would include the graphic image and customized text selected by the sender and the negotiable payment instrument would include the payee and the monetary value selected by the sender. In some cases the payee will be the same as the recipient. In other cases, the payee and recipient may be different individuals or entities. Additionally, in some cases, the negotiable payment instrument will be removeably attached to the message. Further, the message and the negotiable payment instrument may also be printed on the same paper form at the same time.

The method would further include the steps of enabling the sender to select an occasion for sending the message and payment instrument to the recipient and presenting the sender with a proposed graphic image and proposed customized text for inclusion in the message based on the occasion selected by the sender.

In another aspect of the invention, the method would further include the step of displaying a data entry form to the sender over a computer network, in which the form has a plurality of data entry fields for displaying the graphic image, the customized text, the payee, and the monetary value of the negotiable payment instrument. Additionally, in another aspect of the present invention, the data displayed in the plurality of data entry fields is modifiable by the sender.

The method further includes the step of receiving contact information for the recipient of the message, either by enabling the sender to input the contact information or by enabling the sender to select the recipient from an address book listing available recipients. Conversely, the method further includes the step of receiving contact information for the sender.

In another aspect of the present invention, the method includes the step of enabling the sender to input billing information to pay for the creation of the message and the negotiable payment instrument. Additionally, payment authorization can be requested using the billing information obtained from the sender.

Additionally, the method may further include the steps of presenting the sender with a preview of the printed message and negotiable payment instrument and enabling the sender to specify a delivery date for the message and negotiable payment instrument.

Another aspect of the present invention includes a system for enabling a sender to order and have delivered to a recipient a customized greeting message having a negotiable payment instrument included therewith, the system having means for selecting a graphic image for inclusion in the message, means for specifying customized text for inclusion in the message, means for specifying a payee for the negotiable payment instrument, means for selecting the monetary value of the negotiable payment instrument, means for printing the message and negotiable payment instrument, and means for mailing the message and negotiable payment instrument to the recipient.

The system may further include means for displaying a data entry form to the sender over a computer network, in which the form has a plurality of data entry fields for displaying the graphic, the customized text, and the monetary value of the negotiable payment instrument. In another aspect of the present invention, the information displayed in the plurality of data entry fields is modifiable by the sender.

The system may further include means for selecting the occasion for sending the message and negotiable payment instrument. In such cases, the graphic image and customized text are pre-selected based on the occasion. Further, the graphic image and customized text may be modifiable by the sender.

In another aspect of the present invention, the system may further include means for displaying a preview of the printed message and the negotiable payment instrument to the sender and means for enabling the sender to specify a delivery date for the message and negotiable payment instrument.

As with the above method, in the system of the present invention the recipient and the payee may be the same or different. Further, the negotiable payment instrument may be removeably attached to the message and printed on the same paper form at the same time.

### BRIEF DESCRIPTION OF THE DRAWINGS

A preferred embodiment of the present invention will now be described in detail with reference to the accompanying drawings, wherein:

FIG. 1 illustrates an online ordering and delivery system in accordance with a preferred embodiment of the present invention.

FIG. 2 is a screen shot of an example homepage hosted by a web server for use with the present invention.

FIG. 3, consisting of FIGS. 3A and 3B, is a screen shot illustrating an example data entry web page hosted by the web server of FIG. 2.

FIG. 4, consisting of FIGS. 4A and 4B, is a screen shot illustrating an example preview web page showing an example gift-gram of the present invention.

FIG. 5 is a screen shot illustrating an example data entry page for entering credit card or debit card information for use with the present invention.

FIG. 6 is a screen shot illustrating an example data entry page for entering checking account information for use with the present invention.

FIG. 7 is a flow diagram illustrating the main system routines of the online ordering and delivery system in accordance with a preferred embodiment of the present invention.

FIG. 8 is a flow diagram illustrating the select occasion routine of FIG. 7 in accordance with a preferred embodiment of the present invention.

FIG. 9 is a flow diagram illustrating the data entry routine of FIG. 7 in accordance with a preferred embodiment of the present invention.

FIG. 10 is a flow diagram illustrating the preview gift-gram routine of FIG. 7 in accordance with a preferred embodiment of the present invention.

FIG. 11 is a flow diagram illustrating the process billing information routine of FIG. 7 in accordance with a preferred embodiment of the present invention.

FIG. 12 is a flow diagram illustrating the print and mail routine of FIG. 7 in accordance with a preferred embodiment of the present invention.

### DESCRIPTION OF A PREFERRED EMBODIMENT

The present invention is directed to an online method and system for enabling an individual to order a paper greeting message that can be customized or personalized and having included therewith or attached thereto a negotiable payment instrument, such as a check or money order. The paper greeting message/payment instrument combination will generally be referred to as a “gift-gram.” As used herein, the person ordering the gift-gram will generally be referred to as the “sender.” The person to whom the gift-gram is sent will generally be referred to as the “recipient.” In most cases, the recipient of the gift-gram will also be the payee identified on the payment instrument portion of the gift-gram; however, it is within the scope of the present invention that the gift-gram could be mailed to a specific recipient and the payment instrument could be made out to a different payee. For example, a grandparent could mail the gift-gram to the parent at the parent's address but have the payment instrument made out to the grandchild. Similarly, the payment instrument could be made out to a department store or retail merchant or it could be made out to a payee and a specific merchant or store, if desired.

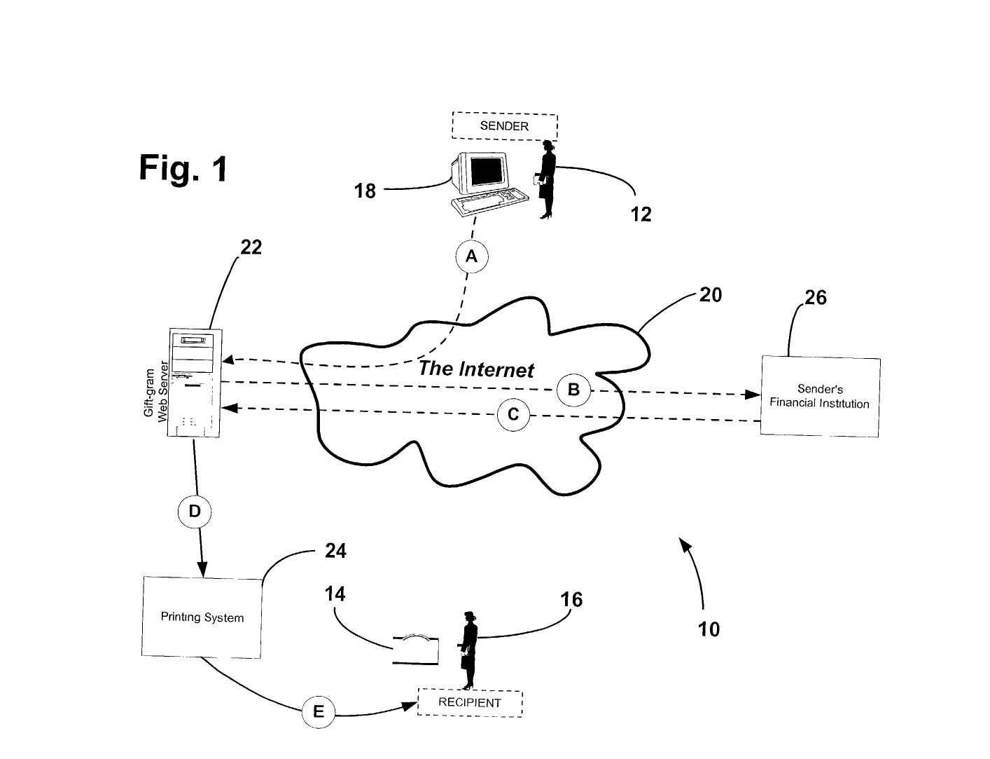

Turning now to the drawings, in which like numerals indicate like components and elements throughout the several drawings and figures, FIG. 1 illustrates an on-line network system 10 for enabling a sender 12 to create a gift-gram 14 and have it sent to a recipient 16 in accordance with a preferred embodiment of the present invention. The system 10 is connected for computer communications via the known world wide computer network, known as the Internet, which is shown generally at 20 and depicted as a “cloud” to indicate the amorphous and nebulous manner in which computers communicate using this network.

The system 10 contemplates the sender 12 having access to a personal computer 18, which would have access to the Internet 20 using any known means, such as phone connection, cable connection, wireless connection, and the like. In addition, the computer 18 would need to have suitable software, such as a “web browser,” to enable the computer 18 to access the online web site or other computer-network accessible facility, hosted by web server 22. Web server 22 can be a standard computer, computer server, or combination of computer servers programmed and configured to host an on-line web site accessible over the Internet 20. Although it is contemplated that the gift-gram 14 of the present invention could be ordered by the sender 12 over the Internet 20 using a computer 18 equipped with a suitable web browser and connected to the web server 22 of the gift-gram producer, other methods of communicating with the computer server of the gift-gram producer, such as a kiosk, a hand-held device, and the like, are also contemplated within the scope of the present invention.

It is further contemplated that web server 22 would be connected, directly, indirectly, or through known networking means, to printing system 24. Using known printing and processing techniques, the printing system 24 would be capable of printing a high volume of gift-grams with MICR ink using either pre-printed forms or blank forms, folding and inserting each gift-gram into an envelop having a window for the address, and placing proper postage on the outside of each envelop for mailing or other commercial delivery. The system 10 also contemplates inclusion of the sender's financial institution 26, which could be a bank account or credit card account of the sender 12.

FIG. 1 also illustrates a sequence of steps, identified by circled letters, by which the various entities communicate with each other using the present invention. For example, in step A, the sender 12 “orders” a gift-gram 14 online from web server 22. More specifically, sender 12 accesses the web site hosted by the web server 22 over the Internet 20, and the sender 12 and web server 22 communicate back and forth until sufficient information has been exchanged for the gift-gram 14 to be “ordered,” a process which will be described in greater detail hereinafter. Once the gift-gram 14 had been ordered online, web server 22 would communicate with sender's financial institution 26 in step B to request authorization of payment for the cost of the gift-gram 14. In step C, sender's financial institution 26 would authorize or refuse the transaction for the cost of the gift-gram. Although communication between web server 22 and financial institution 26 is shown going through the Internet 20, such communication could also occur through other conventional channels, such as a phone line or secure banking network. In an alternate embodiment (not shown), it is possible for sender 12 to have a money account or stored value account directly with the company that operates web server 22, in which case, authorization of payment would not need to go to sender's financial institution 26, but could take place within web server 22 itself or between web server 22 and another server (not shown) operated by the same company.

In step D, after payment had been authorized, web server 22 would communicate with printer system 24 to initiate actual preparation of the gift-gram 14. Web server 22 would transfer all data and information necessary to fill in all of the “fields” of the gift-gram, as will be described hereinafter. The actual printing process used by printing system 24, including the use of MICR printing techniques, folding of the gift-gram 14, inserting of the gift-gram 14 into an envelop, and the placement of sufficient postage for mailing on the envelop are all known to those skilled in the printing art.

In step E, the gift-gram 14 is actually mailed to recipient 16 using known mailing techniques.

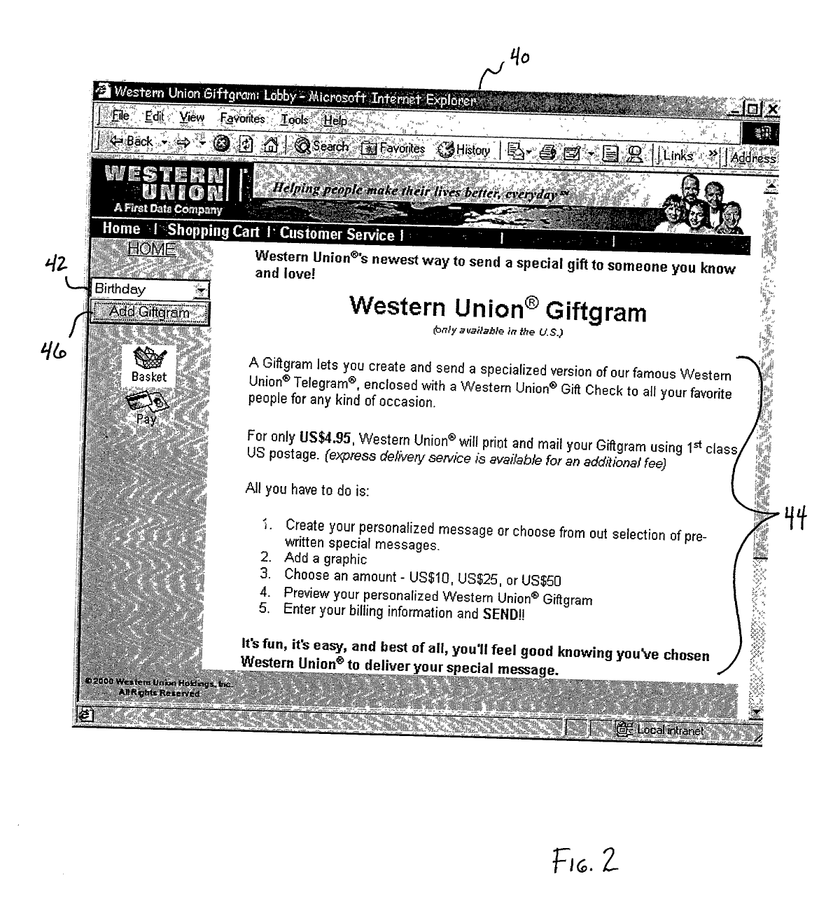

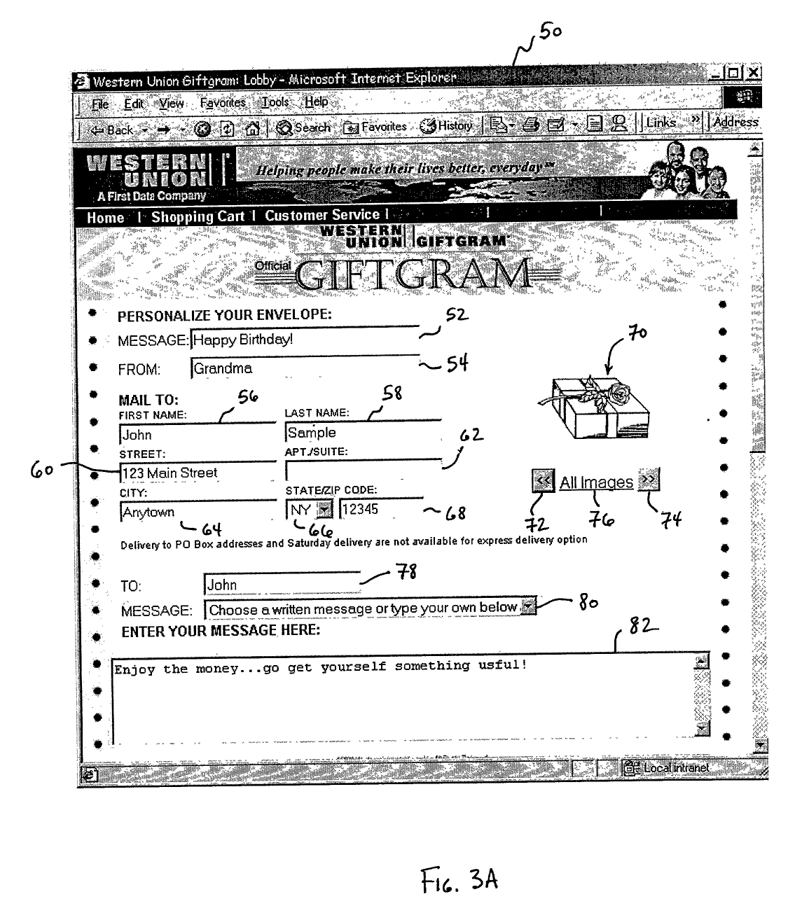

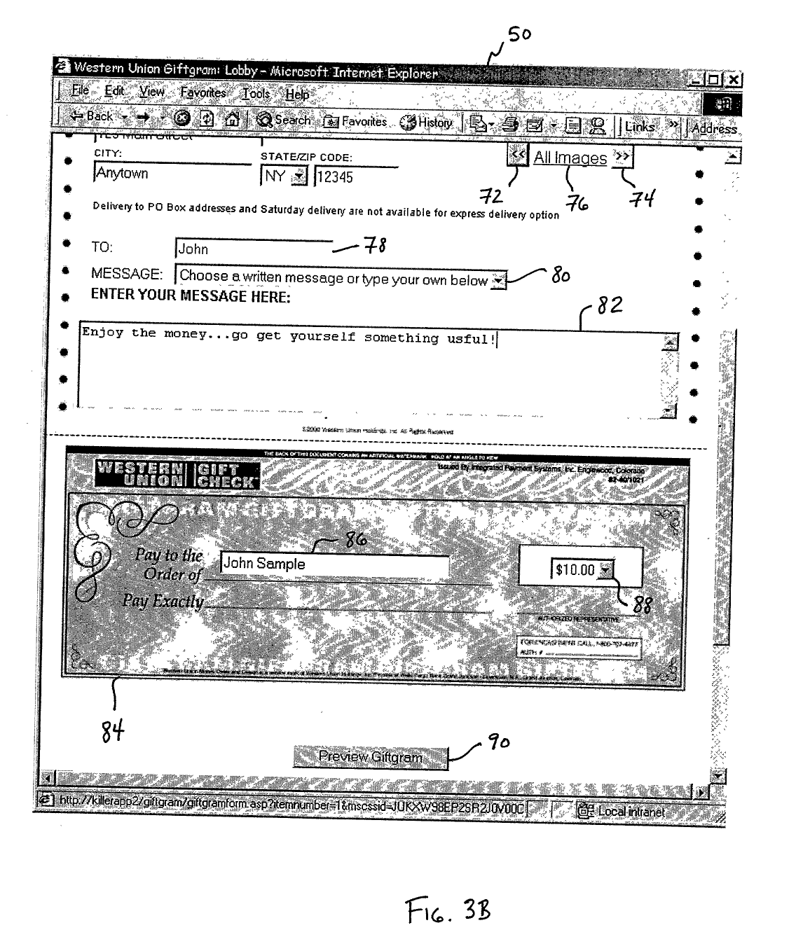

Referring now to FIG. 2, a typical Internet homepage 40 that could be hosted by web server 22 and displayed on sender's computer 18 using a suitable web browser is displayed. Although the homepage 40 is shown to be that of Western Union® Gift-graM™, other companies could offer a similar service and product with their own customized web pages and still fall within the scope of the present invention. Additionally, although the functionality of the present invention will now be described with reference to specific web pages (FIGS. 2-6), it should be understood that the various functions ascribed to each web page could be rearranged, repositioned, reformatted, and the like, and still fall within the intended scope of the present invention. For example, pull down menu 42 and button 46 (described in greater detail hereinafter) are shown and described with reference to FIG. 2; however, their function could easily be moved to another web page, such as at the beginning of data entry web page 50 of FIG. 3A or to another web page altogether without affecting the functionality and processes of the present invention. As another example, the functionality of homepage 40 and data entry web page 50 could easily be combined into a single web page using known programming techniques, again, without affecting the functionality and processes of the present invention.

Homepage 40 includes general information 44 about the gift-gram web site. In addition, using pull down menu 42, sender 12 can select the “occasion” for the gift-gram, which will determine what preselected graphics and greetings will be offered to the sender on the data entry page 50 (see FIGS. 3A and 3B) and which will appear on the gift-gram 14. By way of example, “birthday” has been selected in pull down menu 42. Other options for the “occasion” for sending the gift-gram 14 are as limitless as the human imagination, but could include such things as Christmas, Easter, Graduation, Wedding, Anniversary, Valentine's Day, Mother's Day, Secretary's Day, and the like. Once the occasion has been selected, sender 12 can select button 46 to proceed to the data entry web page 50.

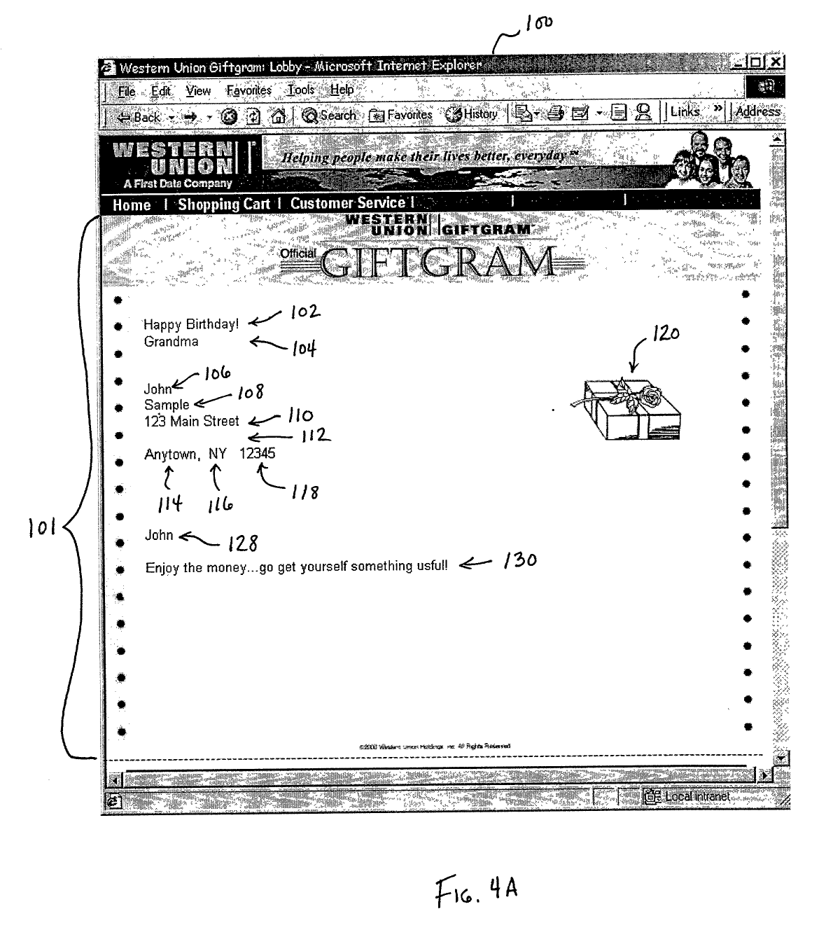

The data entry web page 50 is illustrated in FIGS. 3A and 3B. The message field 52 is pre-populated based on the selected “occasion” chosen in pull down menu 42; however, sender 12 has the option and capability of adding, modifying, or deleting the preselected message by moving the cursor into the field and typing a new message in known manner. The sender 12 next proceeds to the “from” field 54 to input her “informal” title based on her relationship, if any, with the recipient 16. Optionally, if this field is left blank, then the sender's actual name, obtained from the billing information data entry web pages (described hereinafter) or from the web server database, can be used as the default name in field 104, as shown in FIG. 4A. Next the sender enters the name 56, 58, street address 60, 62, city 64, state 66, and zip code 68 of the recipient 16. Although not shown, it would be easy to include on the data entry web page 50 a link to an address book maintained by the web server 22 having a list of recipients previously entered by the sender 12 and from which fields 56-68 could be automatically filled by merely selecting the name of the intended recipient 16 from the address book. Like message field 52, graphic 70 is pre-selected based on the selection chosen in pull down menu 42. Note, however, that the sender 12 has the option of scrolling backward 72, scrolling forward 74, or viewing all available images 76 in the web server database by selecting the appropriate button on the screen in known manner. If the sender 12 scrolls forward or backward, a new graphic image will appear in place of graphic 70. If the sender 12 decides to view all available images 76, such images would either be displayed in a new “window” on the computer screen or displayed in a designated area on the data entry web page 50. If the sender selects a new image from the displayed images, again, that new image will appear in place of the graphic 70. Field 78 is automatically filled in using the information entered into field 56; however, if desired, sender 12 can input a different name if she wants the payment instrument made payable to a payee(s) different from the recipient of the gift-gram specified in fields 56 and 58. In pull down menu 80, the sender 12 can select from a number of pre-written messages, which will then appear in window 82. The list of available pre-written messages is pre-populated based on the occasion selected by the sender 12. If desired, the sender 12 can add, modify, or delete the pre-written message in window 82. The sender 12 can also create her own personalized message by typing the message directly into window 82 in known manner. A graphic version of the payment instrument 84 appears at the bottom of the data entry screen 50. Field 86 is automatically filled in based on the information entered for fields 56, 58, and 78. If field 78 is the same as field 56 or 56 in combination with field 58, field 86 will be filled in with the information from fields 56 and 58; however, if field 78 is different from field 56 or field 56 in combination with 58, field 86 will be filled in with the data input into field 78. Using pull down menu 88, the sender 12 can select how much money she wants to send to recipient 16 as a gift. Generally, sender will be offered several limited choices for amount of the payment instrument, such as $10, $20, $50, and other. If “other” is selected, the sender 12 can input a custom amount of money; however, web server 22 will generally cap the amount at a certain level for fraud and security reasons. Unless the sender 12 decides to change any of the fields in the data entry page 50, which can be done while viewing the page 50, the sender 12 will next be able to preview on her computer 18 how the gift-gram 14 will appear when printed by selecting button 90 in known manner.

FIGS. 4A and 4B illustrate an example gift-gram print preview screen shot 100. The screen shot roughly approximates the proportions the gift-gram 14 will have once printed. In the preferred embodiment, the upper two thirds of the preview screen contain the greeting portion 101 and the lower one third contains the payment instrument 134. The actual proportions between the greeting portion 101 and the payment instrument 134 of the actual gift-gram 14 can vary within the scope of the present invention. Preferably, the gift-gram 14 is printed as a single sheet with the payment instrument portion detachable from the greeting portion for ease in cashing the same. The two portions are separated by a simulated perforation 132, which corresponds with the perforation that occurs on the preferred version of the actual gift-gram 14. The greeting portion 101 contains the message that was entered into field 52. The informal title 104 is the one that the sender 12 entered into field 54. The recipient's name 106, 108 corresponds to that entered into fields 56, 58, respectively. The recipient's address 110, 112 corresponds to that entered into fields 60, 62, respectively. And the recipient's city 114, state 116, and zip code 118 correspond to that entered into fields 64, 66, and 68, respectively. Graphic 120 correspond to whichever graphic 70 was finally selected by the sender 12 as described previously. The “to” line 128 corresponds with the name entered into field 78, and the message 130 corresponds with the message entered into field 82. The graphic version of the payment instrument 134 shows the payee 136, which corresponds with the payee shown in field 86. The amount 138 of the payment instrument corresponds with the amount selected in pull down menu 88.

After previewing the graphic version of the payment instrument, the sender 12 has the option of going back and making changes to any of the data entry fields by selecting button 140, which returns the sender 12 to the data entry web page 50. If the sender 12 wants to create an additional gift-gram to send to someone else, the sender 12 can select a new “occasion” from pull down menu 142 and then go to a new data entry web page 50 by selecting button 144. Alternatively, if the sender 12 does not want to create any additional gift-grams, the sender can select button 146 to complete the processing of the order.

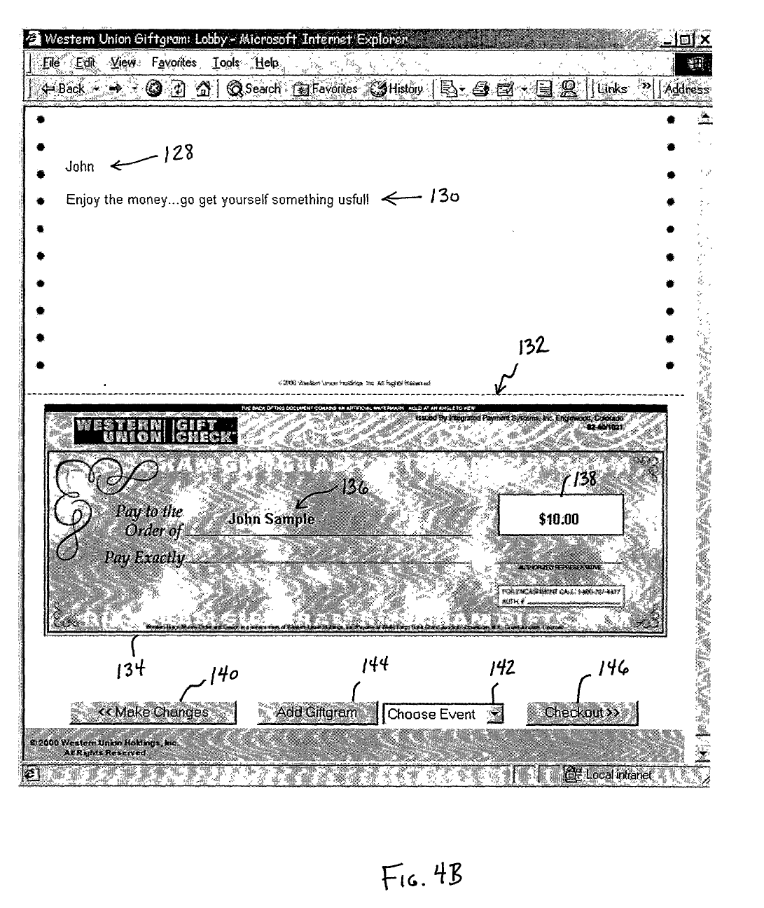

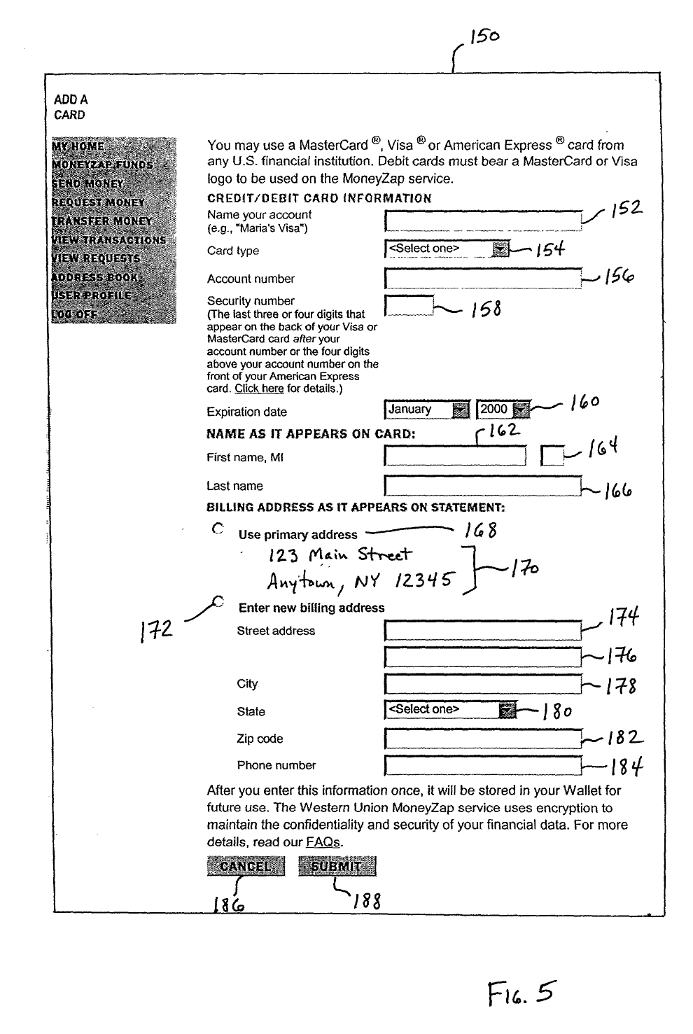

The sender 12 would then go to a check out web page (not shown). At the check out page, the sender 12 would first be given the opportunity to select delivery method, such as First Class Mail, Priority Mail, or Express Mail, for sending the gift-gram 14 to the recipient 16. Once this option had been chosen, the cost for sending the gift-gram would be presented to the sender 12. If the sender 12 had previously registered with the web server 22, the sender would be given the opportunity of paying for the gift-gram 14 using a predefined credit card, debit card, or checking account. If the sender 12 had not previously registered or desired to register a new payment method, the sender would be directed to an account setup screen such as those shown in FIGS. 5 and 6.

FIG. 5 illustrates an example of a credit card/debit card entry web page 150. Such a web page is conventional and would contain data entry fields, such as account name 152, card type 154, account number 156, security number 158, expiration month and year 160, first name 162, middle initial 164, and last name 166, as they appear on the card. The sender 12 would also specify a primary address 168, which would be pre-filled using sender's home address 170 if known, or a new billing address 172, if different from 170. Address fields 174, 176, 178, 180, 182, and 184 are self-explanatory. At the end of the data entry web page, the sender 12 could select the cancel button 186 to delete the field entries and return to the previous web page or select the submit button 188 to have the account set up and processed.

FIG. 6 merely illustrates an example of a checking account setup web page 190, which is also conventional. This web page would include data entry fields, such as check number 192, account information 194, a confirmation of account information 196, a name of the account 198, a driver's license or state ID number 200, and the state 202 in which such ID was issued. At the end of this data entry web page 190, the sender 12 could select the cancel button 204 to delete the field entries and return to the previous web page or select the submit button 206 to have the account set up and processed.

Once billing information was entered and selected by the sender 12, the web server 22 would request and wait for fund authorization from the sender's financial institution 26 before initiating a print command to printing system 24, as described previously. Although not shown, on the check out page, the sender 12 could enter a desired date in the future for mailing of the gift-gram 14. Such date could be set and web server 22 would delay sending the printing command to the printer system 24 until such a date, provided fund authorization had been received prior to the requested mailing date.

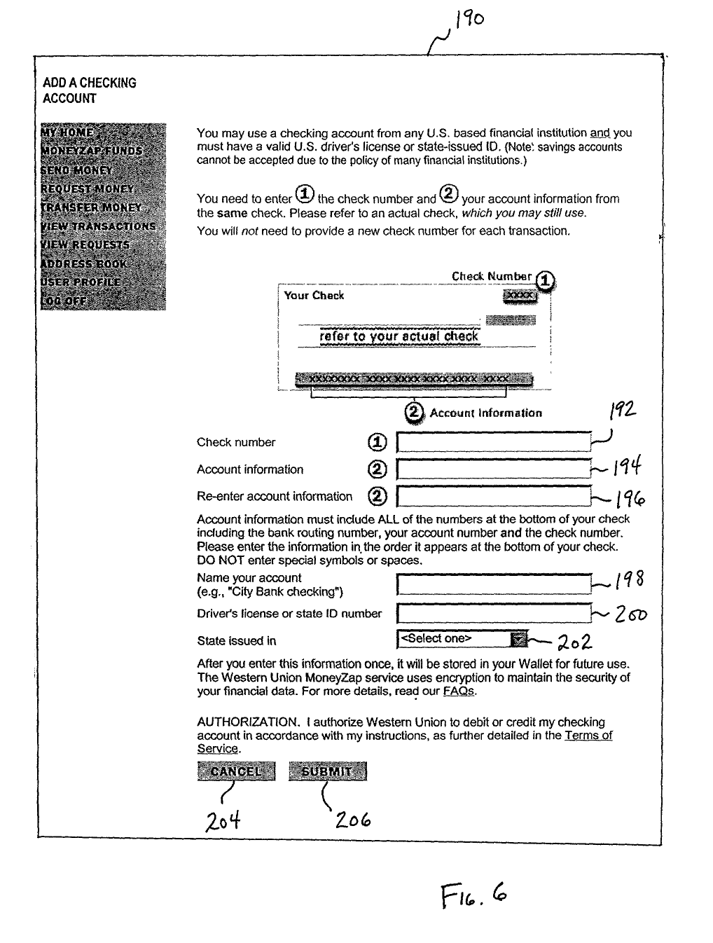

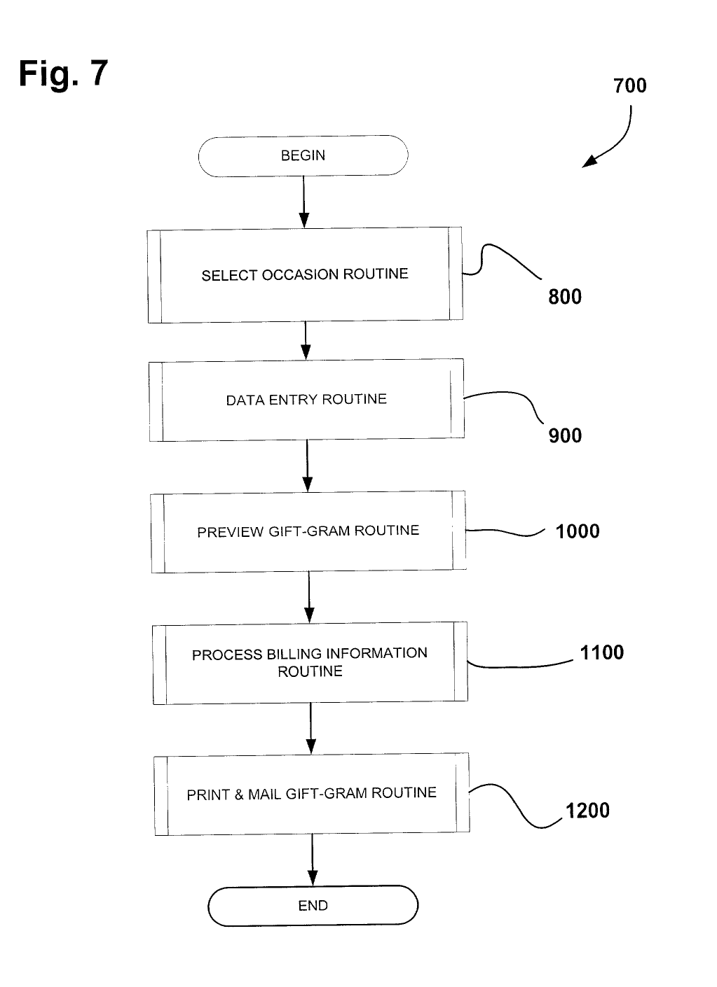

Turning now to FIGS. 7-12, the methods and processes of the present invention as previously described are shown in flow chart format. More specifically, FIG. 7 illustrates the main process system 700, which comprises the main sequence of routines taken by on-line network system 10. Once sender 12 accesses the web server 22, a select occasion routine 800 is initiated. Once the select occasion routine 800 is completed, the data entry routine 900 is initiated. This same process repeats through the preview gift-gram routine 1000, the process billing information routine 1100, and the print and mail routine 1200.

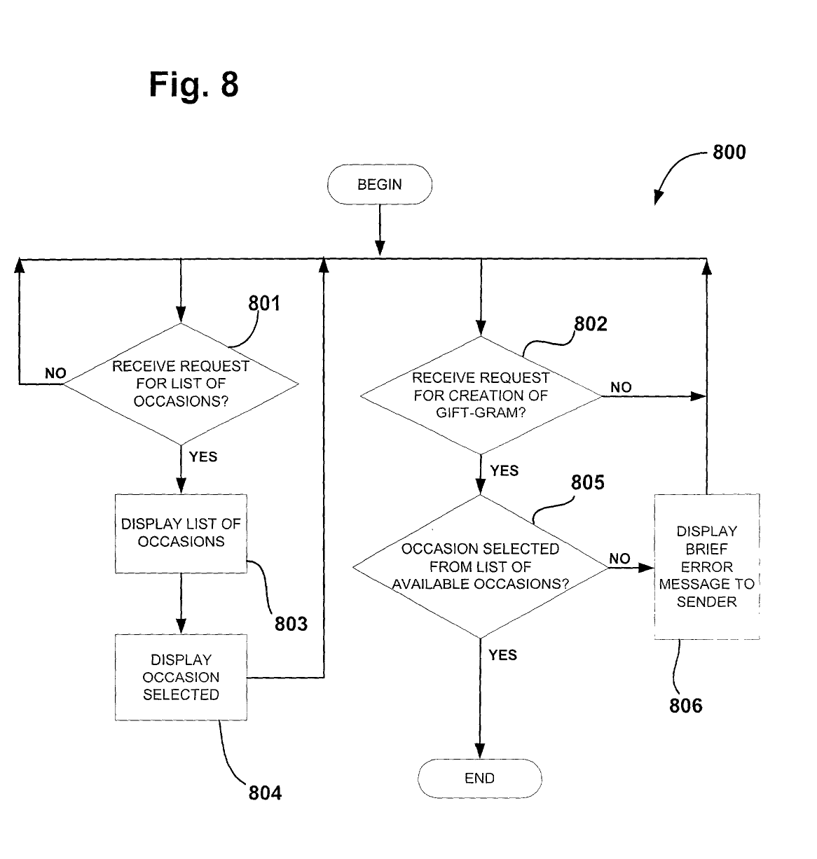

Referring now to FIG. 8, the select occasion routine 800 will be discussed in greater detail. Beginning at steps 801 and 802, the system runs an endless loop waiting for the sender either to request a list of the occasions for sending the gift-gram in step 801 or to request creation of a gift-gram in step 802. For reasons that will become apparent, the sender is first required to request the list of occasions available in step 801. Once this is done, the system proceeds to step 803 and displays the list of available occasions for which gift-grams can be created using the system. The displayed list may be in a pull-down menu format, such as that shown by menu 42 in FIG. 2. Once the sender selects one of the occasions from the list of available occasions, the system proceeds to step 804 and displays the selected “occasion” in the main window of the pull down menu 42. The system then returns to the endless loop, again, waiting for the sender either to request a list of the occasions for sending the gift-gram in step 801 or to request creation of a gift-gram in step 802. If the sender requests to create a gift-gram in step 802, in step 805 the system verifies that the sender has actually selected an occasion from the list of occasions available. If none has been selected, the system displays a brief message to the sender in step 806 requesting that she select an occasion. If an occasion has been selected, the system proceeds to the data entry routine 900.

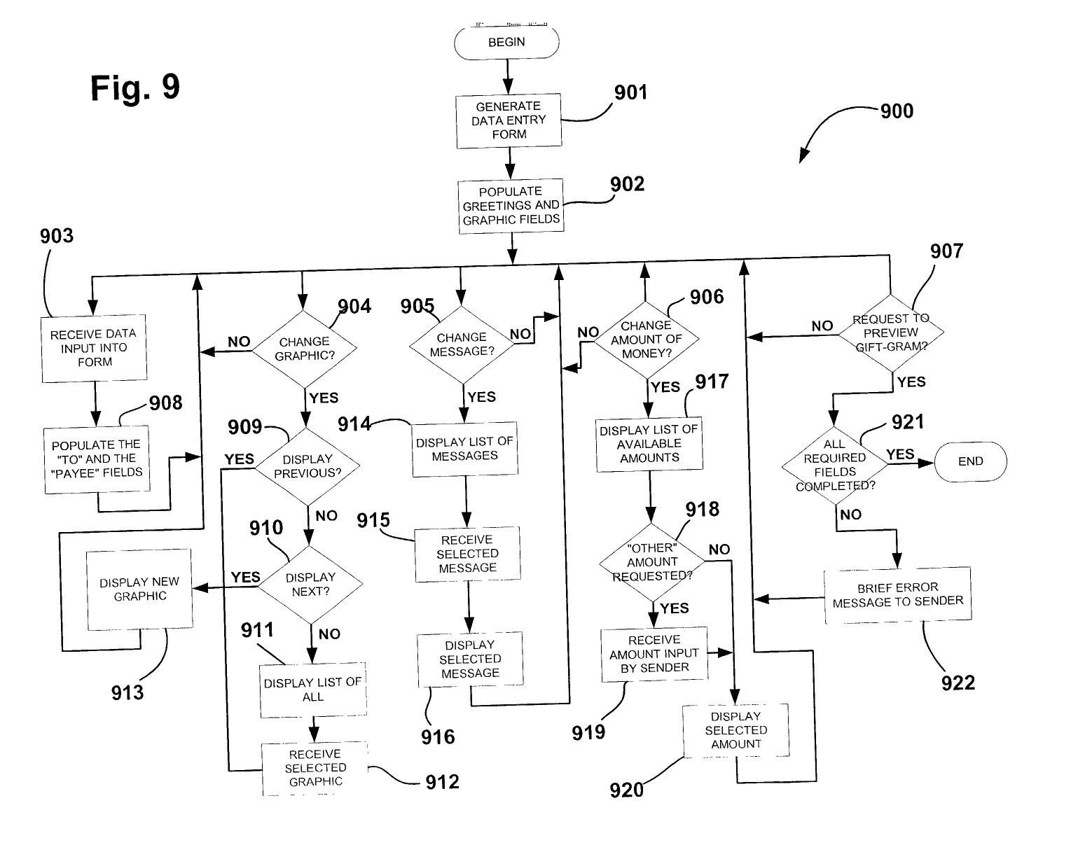

Referring now to FIG. 9, the data entry routine 900 is illustrated. Beginning at step 901, the system generates a data entry form web page. Next, in step 902, the system pre-populates the greeting fields and displays a graphic in the graphics field based on the occasion selected by the sender as discussed previously. Next, in steps 903 through 907, the system runs an endless loop waiting for the sender to complete the data entry form and then to request a preview of the gift-gram. As will be explained, the sender cannot proceed to the preview gift-gram routine 1000 until all required information has been input into the data fields. In step 903, the sender inputs data into the data entry fields in the form. In step 908, the system automatically populates the “to” and “payee” data field using information provided by the sender in other data fields. The sender can override the automated entries in step 908 by typing new information directly into the appropriate field during step 903.

In step 904, the sender has the option of changing the graphic previously selected in step 902. In steps 909 and 910, respectively, the sender can request that the “previous” or “next” graphic in the list of available graphics be displayed. Alternatively, in step 911, the sender can request that all available graphics be displayed for selection purposes. In step 912, the sender selects one of the available graphics. In step 913, the selected graphic is displayed in the data entry form in place of the originally pre-selected graphic.

In step 905, the sender has the option of changing the message displayed, for example, in field 82 and previously selected in step 902. In step 914, the list of available pre-written messages is displayed. In step 915, the sender selects one of the pre-written messages. In step 916, the selected message is displayed in the data entry form in place of the originally pre-selected message. Obviously, the sender has the option of adding, modifying, or deleting the message in field 82 by inputting the appropriate text in step 903.

In step 906, the sender has the option of changing the amount of the payment instrument that will be part of the gift-gram. The amount of the payment instrument can be set by default at a minimum level, such as $10.00, and pre-populated in step 902. Alternatively, the amount can be initially left blank, which would require the sender to affirmatively select an amount. In step 917, the list of available amounts of money that can be included on the payment instrument is presented, for example, in a pull down menu format. If the sender selects the “other” option rather than one of the specific amounts presented, the sender is required to input the amount in step 919. The selected amount or the input amount of the payment instrument is then displayed in the relevant data entry field in step 920.

In step 907, the sender has the option of requesting a preview of the gift-gram. In step 921, if all required fields have been completed by the sender or the system, then the system will initiate the preview gift-gram routine 1000. If all of the required data entry fields have not been completed, the sender is presented in step 922 with a brief message explaining that additional information must be entered and the sender returns to the endless loop in which the sender must input data into the data entry fields.

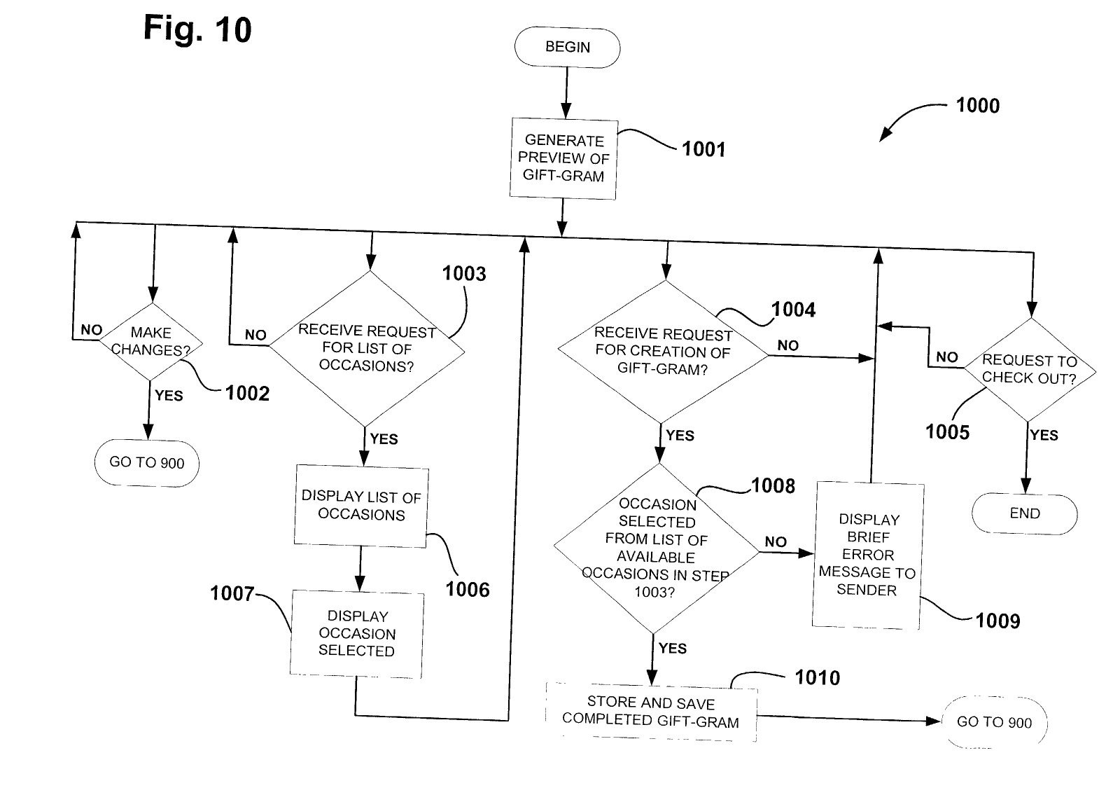

Referring now to FIG. 10, the preview gift-gram routine 1000 is illustrated and will be discussed in greater detail. In step 1001, the system generates a web page preview of approximately what the gift-gram will look like when printed. In steps 1002 through 1005, the system runs an endless loop waiting for the sender to request the opportunity to make changes to the existing gift-gram, to save the existing gift-gram and create a new one, or to request the opportunity to “check out” and send the gift-gram. More specifically, in step 1002, the sender may request the opportunity to make changes to the previously created gift-gram. This allows the sender to make any necessary corrections or modification that she notes while previewing the gift-gram. If the sender wants to make changes, she is sent back to the data entry routine 900.

With steps 1003 and 1004, the sender has the option of saving the current gift-gram and creating a new one. Once again, to create a new gift-gram, the sender is first required to request the list of occasions available in step 1003. Once this is done, the system proceeds to step 1006 and displays the list of available occasions for which gift-grams can be created using the system. The displayed list may be in a pull-down menu format, such as that shown by menu 142 in FIG. 4B. Once the sender selects one of the occasions from the list of available occasions, the system proceeds to step 1007 and displays the selected “occasion” in the main window of the pull down menu 142. The system then returns to the endless loop. If the sender requests to create a new gift-gram in step 1004, in step 1008 the system verifies that the sender has actually selected an occasion from the list of occasions available in step 1003. If none has been selected in step 1003, the system displays a brief message to the sender in step 1009 requesting that she select an occasion. If an occasion has been selected, the system stores and saves the existing gift-gram data and information in step 1010, then the system initiates a new data entry routine 900 for the new gift-gram.

In step 1005, after previewing the gift-gram, the sender has the option of checking out. If the sender requests the check out procedure, the system proceeds to the process billing information routine 1100.

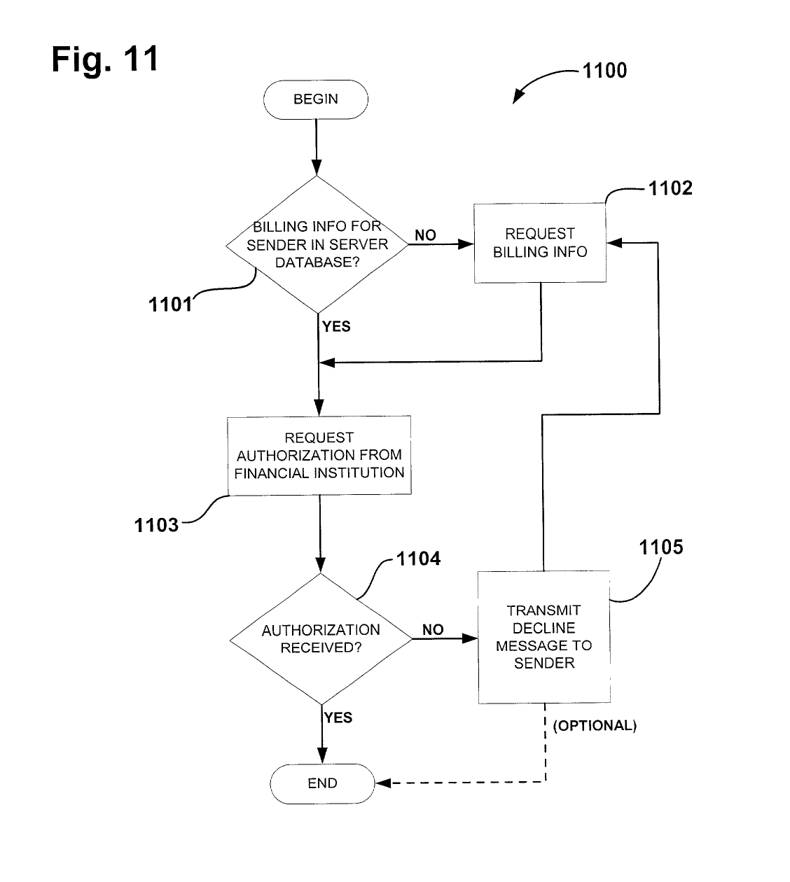

Referring now to FIG. 11, the process billing information routine 1100 is illustrated. In step 1101, the system checks its database to see if the sender has previously submitted billing information, such as through a registration process. If the system does not have any billing information, such as credit card, debit card, or checking account information, the system requests such information in step 1102. Since the inputting of billing information over the Internet is conventional and can be accomplished by data entry web pages, such as those shown in FIGS. 5 and 6, the specific processes are not described in detail herein. Once the system has billing information for the sender, the system sends a request for billing authorization to the financial institution of the sender in step 1103. If billing authorization is not received after a predetermined period of time or if authorization is declined by the financial institution in step 1104, the system transmits a message to the sender in step 1105 explaining the response received from the financial institution. FIG. 11 shows the system returning to step 1102 to receive alternate billing information, such as a different credit card, etc; however, the system could also be set up to end the entire process if payment authorization is not received. In any case, once payment authorization is received in step 1104, the system proceeds to the print and mail gift-gram routine 1200.

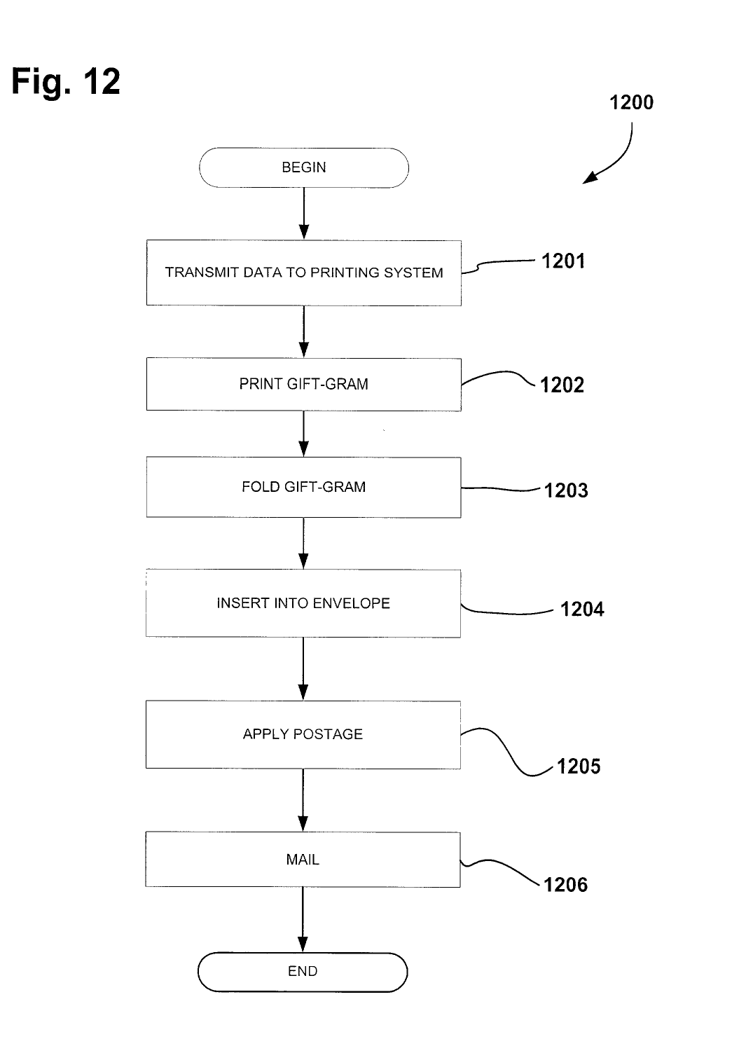

Turning now to FIG. 12, the basic steps of the print and mail gift-gram routine are illustrated. In step 1201, the system transmits to the printing system all of the data and formatting necessary to print the gift-gram. In step 1202, the printing system prints the gift-gram. In step 1203, the gift-gram is cut (if printed from a continuous roll of paper) and the gift-gram is then folded. In step 1204, the gift-gram is inserted into its envelope. Preferably, the mailing address is printed onto the gift-gram during step 1202, and in step 1204, the gift-gram is inserted into its envelope, which has a window through which the address will show. Further, the envelope may also include a “return” address window through which the message and “to” field information from data fields 102 and 104 would show. In step 1205, postage is applied to the envelope. The envelope will vary depending upon whether the gift-gram is being sent by First Class Mail or some other type of express mail delivery. In step 1206, the envelope with the gift-gram is mailed to the recipient. Mailing completes the essential steps of the present routine and overall system. Follow-up mail tracking, although potentially available, is known in the art and beyond the scope of the present invention.

While much of the present invention is intended to be practiced via computers, no specific software or logic circuit is intended nor is required to be used in the practicing of the present invention. Indeed, it would be a matter of routine skill to select an appropriate conventional computer system and implement the claimed process on that computer system. Accordingly, it is intended that any “means for” claims set forth herein encompass any computer embodiment of the corresponding method claims.

It will therefore be readily understood by those persons skilled in the art that the present invention is susceptible of broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. In a computerized system, a method of creating a printed greeting message having a negotiable payment instrument included therewith, comprising the steps of:
(a) enabling a sender of the message to select a graphic image for inclusion in the message to a recipient;
(b) enabling the sender to input customized text for inclusion in the message;
(c) enabling the sender to specify a payee for the negotiable payment instrument;
(d) enabling the sender to specify the monetary value of the negotiable payment instrument;
(e) printing the message and negotiable payment instrument, the message including the graphic image and customized text selected by the sender, the negotiable payment instrument including the payee and the monetary value selected by the sender.

2. The method according to claim 1, further comprising the steps of:
(a) enabling the sender to select an occasion for sending the message and payment instrument to the recipient;
(b) presenting the sender with a proposed graphic image and proposed customized text for inclusion in the message based on the occasion selected by the sender.

3. The method according to claim 1, further comprising the step of displaying a data entry form to the sender over a computer network, the form having a plurality of data entry fields for displaying the graphic image, the customized text, the payee, and the monetary value of the negotiable payment instrument.

4. The method according to claim 3, wherein data displayed in the plurality of data entry fields is modifiable by the sender.

5. The method according to claim 1, further comprising the step of receiving contact information for the recipient of the message.

6. The method according to claim 5, further comprising the step of enabling the sender to input the contact information for the recipient.

7. The method according to claim 5, further comprising the step of enabling the sender to select the recipient from an address book listing available recipients.

8. The method according to claim 1, further comprising the step of receiving contact information for the sender.

9. The method according to claim 1, further comprising the step of enabling the sender to input billing information to pay for the creation of the message and the negotiable payment instrument.

10. The method according to claim 9, further comprising the step of requesting payment authorization using the billing information obtained from the sender.

11. The method according to claim 1, further comprising the step of presenting the sender with a preview of the printed message and negotiable payment instrument.

12. The method according to claim 1, further comprising the step of enabling the sender to specify a delivery date for the message and negotiable payment instrument.

13. The method according to claim 1, wherein the recipient and the payee are the same.

14. The method according to claim 1, wherein the recipient and the payee are different.

15. The method according to claim 1, wherein the negotiable payment instrument is removeably attached to the message.

16. The method according to claim 15, wherein the message and the negotiable payment instrument are printed on the same paper form.

17. A system for enabling a sender to order and have delivered to a recipient a customized greeting message having a negotiable payment instrument included therewith, comprising:
(a) means for selecting a graphic image for inclusion in the message;
(b) means for specifying customized text for inclusion in the message;
(c) means for specifying a payee for the negotiable payment instrument;
(d) means for selecting the monetary value of the negotiable payment instrument;
(e) means for printing the message and negotiable payment instrument; and
(f) means for mailing the message and negotiable payment instrument to the recipient.

18. The system according to claim 17, further comprising means for displaying a data entry form to the sender over a computer network, the form having a plurality of data entry fields for displaying the graphic, the customized text, and the monetary value of the negotiable payment instrument.

19. The system according to claim 18, wherein information displayed in the plurality of data entry fields is modifiable by the sender.

20. The system according to claim 17, further comprising means for selecting the occasion for sending the message and negotiable payment instrument.

21. The system according to claim 20, wherein the graphic image and customized text are pre-selected based on the occasion.

22. The system according to claim 21, wherein the graphic image and customized text are modifiable by the sender.

23. The system according to claim 17, further comprising means for displaying a preview of the printed message and the negotiable payment instrument to the sender.

24. The system according to claim 17, further comprising means for enabling the sender to specify a delivery date for the message and negotiable payment instrument.

25. The system according to claim 17, wherein the recipient and the payee are the same.

26. The system according to claim 17, wherein the recipient and the payee are different.

27. The system according to claim 17, wherein the negotiable payment instrument is removeably attached to the message.

28. The system according to claim 27, wherein the message and the negotiable payment instrument are printed on the same paper form.
